(19) United States
(12) Patent Application Publication
(10) Pub. No.: US 2025/0392039 A1
(43) Pub. Date: Dec. 25, 2025

(54) RF MODULE FOR ANTENNA AND ANTENNA APPARATUS INCLUDING SAME

(71) Applicant: KMW INC., Hwaseong-si, Gyeonggi-do (KR)

(72) Inventors: Oh Seog CHOI, Hwaseong-si (KR); Seong Man KANG, Hwaseong-si (KR); Hyoung Seok YANG, Hwaseong-si (KR); Yong Won SEO, Hwaseong-si (KR); Myung Hwa KIM, Hwaseong-si (KR); Jang Soon PARK, Hwaseong-si (KR); Jae Hong KIM, Yongin-si (KR); Se Kwang YUN, Gwangmyeong-si (KR); Hwan CHOI, Suwon-si (KR); Jeong Moon OH, Hwaseong-si (KR); Sung Ho JANG, Yongin-si (KR); Hoon KIM, Hwaseong-si (KR)

(73) Assignee: KMW INC., Hwaseong-si, Gyeonggi-do (KR)

(21) Appl. No.: 19/308,200

(22) Filed: Aug. 23, 2025

Related U.S. Application Data
(63) Continuation of application No. PCT/KR2024/002364, filed on Feb. 23, 2024.

(30) Foreign Application Priority Data
Feb. 23, 2023 (KR) 10-2023-0024291
Feb. 22, 2024 (KR) 10-2024-0025996

(51) Int. Cl. H01Q 1/52; H01Q 1/42

(52) U.S. Cl. CPC H01Q 1/523; H01Q 1/42

(57) ABSTRACT

Disclosed herein is a radio frequency (RF) module for antennas and an antenna apparatus including the RF module. The RF module includes a plurality of RF filter units each including a filter body formed to be elongated in a vertical direction, and a plurality of radiating element units detachably secured and electrically connected to respective front ends of the RF filter units. Each RF filter unit include the filter body including a left filter and a right filter which are respectively provided in a form of cavities on one side and a remaining side in a width direction of the filter body, and a common resonant component disposed on an end of each of at least two or more multi-bands built in the left filter and the right filter. This configuration may enable simple installation and replacement, and may improve overall communication efficiency of the antenna apparatus.

### TECHNICAL FIELD

The present disclosure relates to a radio frequency (RF) module for antennas and an antenna apparatus including the RF module, and more particularly, to an RF module for antennas and an antenna apparatus including the RF module, which may minimize radio wave interference between modules, prevent indirect coupling between beams radiated from a radiation element unit, and mitigate problems related to passive intermodulation distortion (PIMD).

### BACKGROUND ART

Base station antennas, including those used in repeaters for mobile communication systems, have various forms and structures, and typically have a structure in which a plurality of radiation elements are appropriately arranged on at least one reflector that extends vertically in a longitudinal direction.

Recently, research has been actively conducted to achieve compactness, weight reduction, and low-cost structures in a manner that satisfies high-performance requirements for multiple-input multiple-output (MIMO)-based antennas. In particular, in the case of antenna apparatuses to which patch-type radiation elements are applied to implement linear polarization or circular polarization, a widely used method involves plating the radiation elements formed of a dielectric substrate made of a plastic or ceramic material, and coupling the plated radiation elements to a printed circuit board (PCB) or the like through soldering.

However, in the case of MIMO-based antenna apparatuses, a large number of components need to be densely installed, and the entire product is required to be formed to extend in a vertical direction to enable smooth beamforming. Accordingly, research on addressing passive intermodulation distortion (PIMD), which has been a chronic issue for communication device manufacturers, needs to be prioritized.

In addition, placing a plurality of antenna elements under spatial constraints may cause coupling between the antenna elements. As the coupling among the antenna elements increases, signal leakage may occur, which may lead to a decrease in overall efficiency of the antenna apparatus.

Accordingly, research and development of an antenna apparatus configured to secure sufficient channel capacity and enable decoupling between antenna elements needs to be conducted in advance. In this case, configuring the antenna apparatus so that the overall size does not increase is also an important research challenge.

### DISCLOSURE

### Technical Problem

The present disclosure has been made in an effort to solve the above-mentioned technical problem, and an object of the present disclosure is to provide a radio frequency (RF) module for antennas, which is manufactured on a module basis and disposed in an antenna housing, and which is capable of minimizing radio wave interference between RF modules and addressing problems related to passive intermodulation distortion (PIMD), and an antenna apparatus including the RF module.

Another object of the present disclosure is to provide an RF module for antennas, which enables decoupling among a plurality of antenna elements densely installed, thereby preventing an increase in the overall size of the antenna apparatus, and an antenna apparatus including the RF module.

Technical objects of the present disclosure are not limited to the aforementioned objects, and other objects not described above may be evidently understood from the following description by those skilled in the art.

### Technical Solution

A radio frequency (RF) module for antennas according to an embodiment of the present disclosure may include a plurality of RF filter units each including a filter body formed to be elongated in a vertical direction, and a plurality of radiating element units detachably secured and electrically connected to respective front ends of the plurality of RF filter units. Each of the plurality of RF filter units may include the filter body comprising a left filter and a right filter respectively provided in a form of cavities on one side and a remaining side in a width direction of the filter body, and a common resonant component disposed on an end of each of at least two or more multi-bands built in the left filter and the right filter of the filter body.

Here, the common resonant component may include a common resonator disposed at a center of the cavities of the left filter and the right filter that include the respective ends of the multi-bands, and a coupler and a divider electrically connected to the common resonator.

Furthermore, the multi-bands may include a plurality of resonators configured to build a plurality of transmission paths that selectively transmit signals of a plurality of frequency bands. The common resonator may be configured to include resonators respectively positioned at input ends and output ends of the plurality of frequency bands.

Furthermore, a signal selected by the common resonator may be transmitted to the plurality of radiating element units or a calibration port via the coupler and the divider.

In addition, the coupler and the divider may be secured to a front end portion of the filter body adjacent to the cavity of the left filter or the right filter.

In addition, each of the coupler may be formed to have a thickness suitable for being inserted and secured in a slit-coupling manner inside a front end portion of the filter body.

An antenna apparatus according to an embodiment of the present disclosure may include: a radio frequency (RF) module for antennas, including a plurality of RF filter units each including a filter body formed to be elongated in a vertical direction; an antenna housing formed in an enclosure shape with an open front side and an internal space formed to receive the RF module; and a radome panel configured to shield an open front end portion of the antenna housing and protect the RF module from an outside. The RF module may include: the filter body including a left filter and a right filter respectively provided in a form of cavities on one side and a remaining side in a width direction of the filter body; and a common resonant component disposed on an end of each of at least two or more multi-bands built in the left filter and the right filter of the filter body.

Here, the RF module may further include a plurality of radiating element units detachably secured and electrically connected to respective front ends of the plurality of RF filter units, the plurality of radiating element units including a plurality of antenna array elements coupled to front ends thereof and configured to output a beam with at least one polarization of dual polarizations. The radome panel may include, on a rear surface thereof, a decoupling pattern portion formed in a predetermined shape to minimize indirect coupling between the plurality of antenna array elements.

Furthermore, the decoupling pattern portion may be formed in an ‘X’ shape among regions provided in a rhombus shape and a honeycomb shape.

Furthermore, the radiating element unit of the RF module may include at least one radome deformation prevention protrusion provided to support a rear surface of the radome panel.

In addition, each of the plurality of radiating element units may include an antenna element board (antenna PCB) which is secured to a front end of the filter body via the radio wave interference isolation walls, and on which a variable circuit pattern electrically connected to a pair of input terminals and a plurality of transmission lines extending to be branched from the variable circuit pattern into at least one branch and electrically connected to a plurality of output terminals each provided as a pair, are printed in patterns. The filter body may be formed with an avoidance portion cut out to prevent interference with power transmission to a variable switch panel that is disposed in front of the variable circuit pattern and configured to move to vary physical lengths of the plurality of transmission lines.

In addition, the common resonant component may include a common resonator disposed at a center of the cavities of the left filter and the right filter that include the respective ends of the multi-bands, and a coupler and a divider electrically connected to the common resonator.

Furthermore, the coupler and the divider may be secured to a front end portion of the filter body adjacent to the cavity of the left filter or the right filter.

### Advantageous Effects

According to a radio frequency (RF) module for antennas and an antenna apparatus including the RF module according to an embodiment of the present disclosure, a plurality of components may be densely installed in a limited space without increasing the size of a product, radio wave interference (coupling) between antenna elements may be minimized, and problems related to passive intermodulation distortion (PIMD) may be mitigated.

### DESCRIPTION OF DRAWINGS

FIG. 1 is a perspective view illustrating an external configuration of a radio frequency (RF) module for antennas and an antenna apparatus including the RF module according to an embodiment of the present disclosure.

FIGS. 2a and 2b are exploded perspective views of a front portion and a rear portion of the configuration of FIG. 1, from which a radome panel is separated forward.

FIG. 3 is an overall exploded perspective view of the configuration of FIG. 1.

FIG. 4 is a rear exploded perspective view of the configuration of FIG. 2, from which an antenna housing is removed.

FIGS. 5a and 5b are front and rear exploded perspective views of the configuration of FIG. 4, with a phase shifter separated apart from the other components.

FIG. 6 is a front exploded perspective view of the configuration of FIG. 2, from which the antenna housing is removed.

FIG. 7 is a cross-sectional view and a partially enlarged view for explaining the function of a support handle in the configuration of FIG. 2.

FIG. 8 is a perspective view illustrating the RF module for antennas according to an embodiment of the present disclosure.

FIGS. 9a and 9b are front and rear exploded perspective views of FIG. 8.

FIG. 10 shows a perspective view (a) and a front view (b) for explaining a radio wave interference isolation wall in the configuration of FIG. 8.

FIG. 11 is a perspective view illustrating an RF filter unit in the configuration of FIG. 8.

FIGS. 12a and 12b are exploded perspective views of (a) and (b) of FIG. 11, respectively.

FIG. 13 is a schematic view for explaining the interference effect affected by the radio wave interference isolation wall of FIG. 10.

FIG. 14 shows a side view (a), a conceptual view (b), and an internal configuration view (c) illustrating a configuration of a common resonant component provided in a filter body of a plurality of RF filter units in the configuration of FIG. 10.

FIG. 15 is a frequency characteristic graph exhibited by the common resonant component of FIG. 14.

FIG. 16 is a perspective view illustrating a coupler in the configuration of FIG. 14.

FIG. 17 is a frequency characteristic graph illustrating passive intermodulation distortion (PIMD) mitigated by the coupler of FIG. 16.

FIG. 18 is a perspective view illustrating installation of a phase shifter that changes the length of a physical transmission line through a variable contact pattern provided in a radiating element unit in the configuration of FIG. 1.

FIGS. 19a and 19b are front and rear perspective views illustrating the phase shifter in a state in which only a single RF module for antennas remains in the configuration of FIG. 18.

FIG. 20 is a diagram illustrating a transmission line configuration for explaining a change in physical transmission length due to the operation of a variable switch panel for the variable circuit pattern of FIG. 18.

FIGS. 21a and 21b are front and rear exploded perspective views illustrating a drive unit among the components of the phase shifter of FIG. 18.

### DESCRIPTION OF REFERENCE NUMERALS

100: antenna apparatus
110: antenna housing
110S: internal space
120: main board
150: radome panel
151: fastening clip
155: decoupling pattern portion
200: RF filter unit
210: filter body
215: resonator
220L: left filter
220R: right filter
230A˜230D: filter brackets
235: fastening screw
250: input port portion
250A˜250D: coaxial connectors (DCCs)
260: output port portion
270L: left filter cover
270R: right filter cover
280L, 280R: filter tunning cover
291: coupler
292: divider
300: radiating element unit
310: antenna element board
320: balun
330: antenna array element
500: AFEM
600: phase shifter
610: drive motor unit
611: motor box
612: first pinion gear
613: rotation shaft
614: second pinion gear
615L, 615R: interlocking second-pinion gears
616L, 616R: interlocking bevel gears
617L, 617R: vertical moving guide blocks
617′: screw rod
620: vertical moving guide unit
621: front motor mounting bracket
622L, 622R: left and right motor mounting brackets
623L, 623R: moving guide slots
630: vertical moving panel
640: vertical connection bar
650: horizontal mounting bar
655U, 655D: vertical mounting bars
660: variable switch panel
669: rotation connection point

### BEST MODEL

Hereinafter, a radio frequency (RF) module for antennas and an antenna apparatus including the RF module according to an embodiment of the present disclosure will be described in detail with reference to the attached drawings.

It should be noted that in assigning reference numerals of each drawing, like reference numerals refer to like elements as much as possible even though like elements are shown in different drawings. Furthermore, in the following description of embodiments of the present disclosure, detailed descriptions of related known configurations or functions will be omitted when it is determined that the detailed descriptions would obscure the understanding of the embodiments of the present disclosure.

In addition, the terms first, second, A, B, (a), and (b) may be used to describe elements of the embodiments of the present disclosure. These terms are used only for the purpose of discriminating one constituent element from another constituent element, and the nature, the sequences, or the orders of the constituent elements are not limited by the terms. Furthermore, unless otherwise defined, all terms used herein, including technical or scientific terms, have the same meaning as commonly understood by those skilled in the art to which the present disclosure pertains. The terms such as those defined in commonly used dictionaries should be interpreted as having meanings consistent with meanings in the context of related technologies and should not be interpreted as ideal or excessively formal meanings unless explicitly defined in the present application.

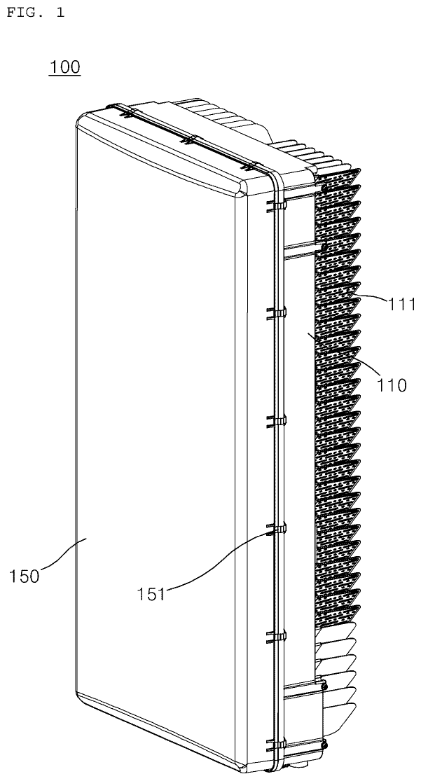

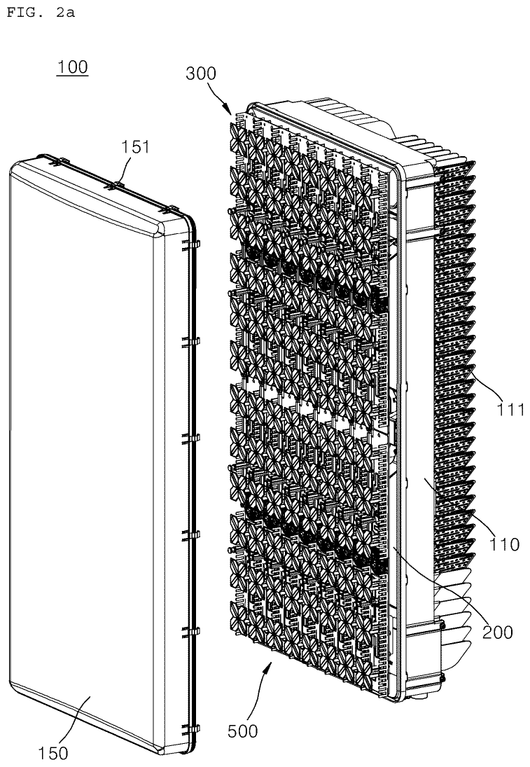

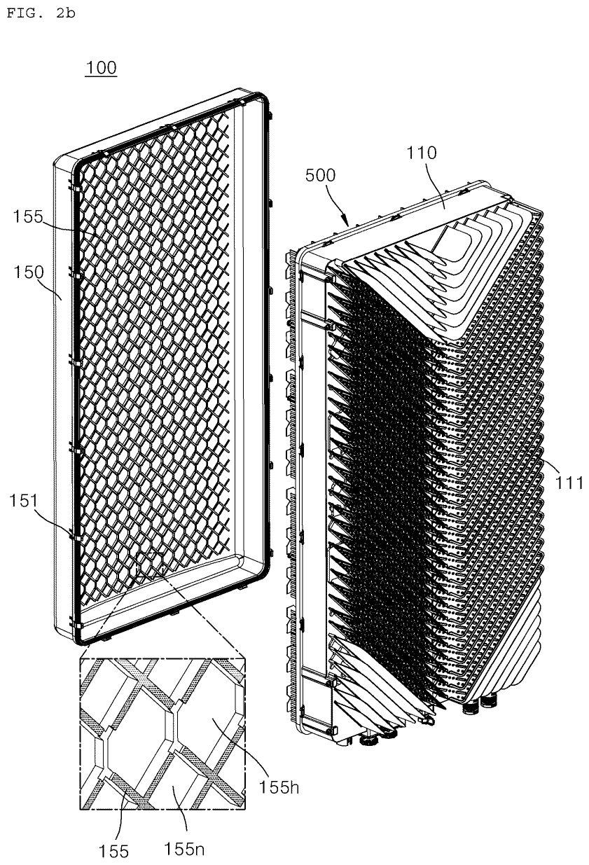

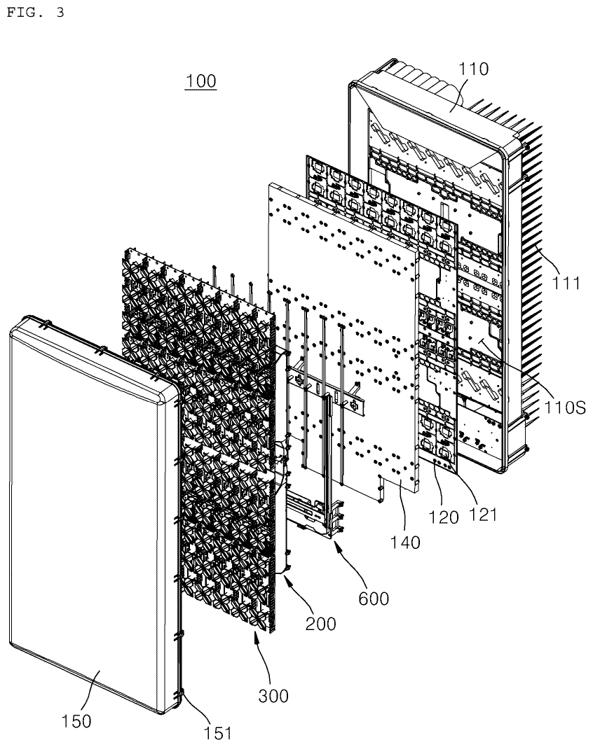

FIG. 1 is a perspective view illustrating an external configuration of an RF module for antennas and an antenna apparatus including the RF module according to an embodiment of the present disclosure. FIGS. 2a and 2b are exploded perspective views of a front portion and a rear portion of the configuration of FIG. 1, from which a radome panel is separated forward. FIG. 3 is an overall exploded perspective view of the configuration of FIG. 1.

As referred to in FIGS. 1 to 3, an antenna apparatus 100 according to an embodiment of the present disclosure includes an antenna housing 110 formed in an enclosure shape with an open front side and an internal space 110S, in which an antenna RF module 500, a main board 120, and the like, described below, are installed in a stacked manner. The antenna housing 110 is formed to be elongated in a vertical direction.

A radome panel 150 is installed on an open front portion of the antenna housing 110 to provide shielding, so that the antenna RF module 500 and the like, which are installed in the internal space, can be protected from the outside. The radome panel 150 may be formed of a material that allows transmission of frequency radiation beams radiated from a plurality of antenna front-end modules (AFEMs) 500 described below.

The radome panel 150 may be disposed to be spaced apart from front ends of the plurality of AFEMs 500 by a predetermined distance to serve not only to protect the AFEMS 500 from external factors, but also to perform a function of preventing problems that may be caused by coupling between a plurality of antenna array elements 330 of radiating element units 300, described below, through decoupling.

For example, coupling between the plurality of antenna array elements 330 may include direct coupling, in which the plurality of antenna array elements 330 are directly coupled to each other, and indirect coupling, in which at least some of electromagnetic waves radiated from any one antenna array element 330 are reflected by the radome panel 150 and then coupled to another antenna array element 330.

Here, a decoupling pattern portion 155 may be formed on a rear surface of the radome panel 150 to decouple electromagnetic waves radiated from the plurality of antenna array elements 330. The decoupling pattern portion 155 functions to minimize the aforementioned indirect coupling between the antenna array elements 330.

As referred to in FIG. 2b, the decoupling pattern portion 155 may be formed on reinforcing ribs (not designated by a reference numeral) configured such that patterns in an approximately rhombus shape (see reference numeral ‘155n’ in FIG. 2b) or a hexagon shape (see reference numeral ‘155h’ in FIG. 2b) are repeatedly arranged on the rear surface of the radome panel 150.

More specifically, the reinforcing ribs may be formed to protrude rearward on the rear surface of the radome panel 150 such that patterns in a rhombus shape (155n) or a hexagon shape (155h) are repeated along outlines thereof. Some of the reinforcing ribs may be coated with a conductive material by a plating method.

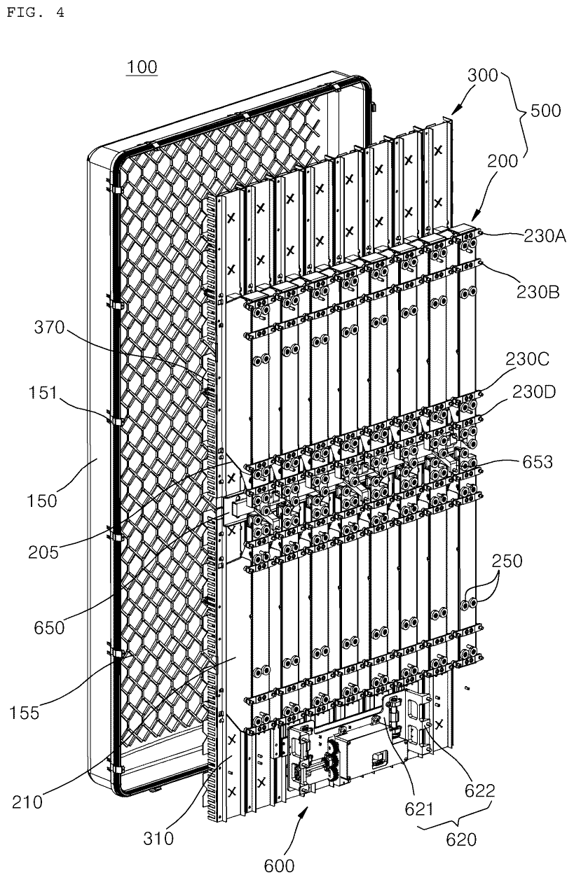

Here, the shape of the decoupling pattern portion 155, coated with the conductive material may be formed in an ‘X’ shape, as referred to in FIGS. 2b and 4.

Some of the electromagnetic waves radiated from some of the plurality of antenna array elements 330 may pass through the radome panel 150, while others may be reflected by the inner surface of the radome panel 150 and cause coupling with other antenna array elements 330. However, due to decoupling through the aforementioned ‘X’-shaped decoupling pattern portion 155, such indirect coupling between the plurality of antenna array elements 330 can be minimized.

To this end, it is preferable that the electromagnetic waves, after being decoupled by the decoupling pattern portion 155, have a phase opposite to that before the decoupling.

In this way, various problems that may be caused by an increase in coupling between the plurality of antenna array elements 330 (e.g., signal leakage and degradation of channel capacity in a multiple-input multiple-output (MIMO) system) may be prevented.

A plurality of fastening clips 151 may be provided on a peripheral edge of the radome panel 150 and spaced apart from each other along a perimeter thereof at predetermined intervals. The radome panel 150 can be detachably secured to the antenna housing 110 by locking each of the fastening clips 151 to a front end portion of the antenna housing 110.

It is preferable that the antenna housing 110 be formed of a material having excellent thermal conductivity as a metal material that facilitates heat transfer (dissipation). In addition, a plurality of heat dissipation fins 111 may be disposed on a rear surface of the antenna housing 110 and configured to receive heat from heat-generating elements 121, which are mounted on the main board 120 placed in the internal space 110S and generate system heat, and to dissipate the heat to an external space.

The plurality of heat dissipation fins 111 may be integrally formed on the rear surface of the antenna housing 110, or may be separately manufactured from the antenna housing 110 and coupled to the rear surface of the antenna housing 110 by a welding method or the like.

In this case, each of the plurality of heat dissipation fins 111 may be formed of aluminum (Al) having high thermal conductivity and provided as a passive heat dissipation structure that dissipates heat only through thermal conductivity of its own material, or may be provided as an active heat dissipation structure filled with a refrigerant and configured to dissipate heat according to a phase change of the refrigerant.

The active heat dissipation structure has an advantage in that a metal base panel made of a material having relatively low thermal conductivity than that of the passive heat dissipation structure can be used, and a greater degree of freedom in selecting refrigerants can also be increased.

As referred to in FIG. 2B, a trench structure (not denoted by a reference numeral) may be provided on the rear surface of the antenna housing 110, the trench structure being open in a region that vertically partitions an exactly central portion between a left end and a right end of the rear surface of the antenna housing 110.

On rear surface regions of the antenna housing 110 corresponding to left and right sides of the trench structure, a plurality of press-fitting portions (not denoted by a reference numeral) may be provided such that the plurality of heat dissipation fins 111, which employ the above-described active heat dissipation structure, are arranged to be obliquely inclined upward toward the left and right ends, respectively.

Here, the plurality of press-fitting portions may be provided to extend obliquely upward to the left and to the right with reference to the trench structure as a center line, and, in the case where the plurality of heat dissipation fins 111 employing the active heat dissipation structure are manufactured to have the same length, heat dissipation fins (not designated by a reference numeral) employing a passive heat dissipation structure may be coupled to press-fitting portions having lengths (or specifications) different from those of the foregoing.

In addition, a predetermined refrigerant capable of phase change may be filled in a region of an upper portion of the trench structure where the heat dissipation fins employing a passive heat dissipation structure are coupled (i.e., an inverted triangular region) and in a region corresponding to the trench structure. Accordingly, heat can be efficiently transferred from the internal space 110S of the antenna housing 110 to the rear surface of the antenna housing 110 through phase change of the refrigerant, whereby heat dissipation performance may be enhanced.

Although not illustrated, the antenna housing 110 may function to mediate coupling with a support pole provided for installation of the antenna apparatus 100.

In addition, although not illustrated, grips that allow a field worker to hold the antenna apparatus 100 according to an embodiment of the present disclosure for transport or for manual installation onto the support pole may further be provided on both left and right sides of the antenna housing 110.

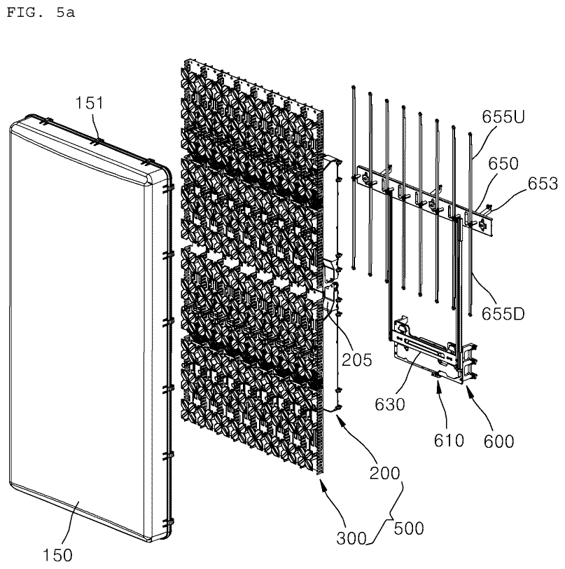

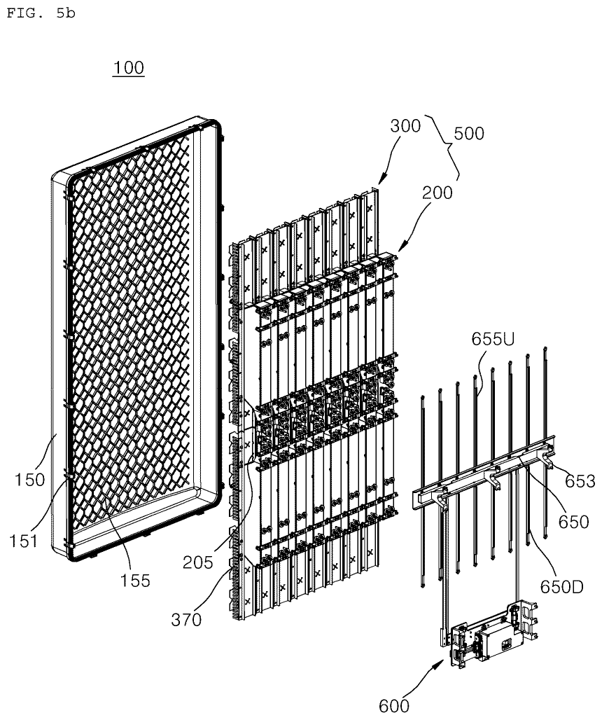

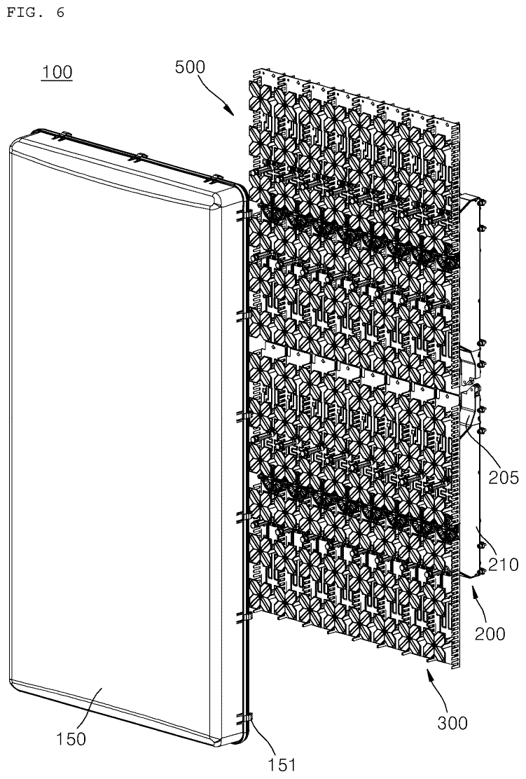

FIG. 4 is a rear exploded perspective view of the configuration of FIG. 2, from which the antenna housing is removed. FIGS. 5a and 5b are front and rear exploded perspective views of the configuration of FIG. 4, with a phase shifter separated apart from the other components. FIG. 6 is a front exploded perspective view of the configuration of FIG. 2, from which the antenna housing is removed.

As referred to in FIGS. 4 to 6, the antenna apparatus 100 according to an embodiment of the present disclosure may include a plurality of RF filter units 200, each including a filter body (see reference numeral 210 in FIGS. 5a and 5b) formed to be elongated in a vertical direction, and a plurality of radiating element units 300, which have a length greater than that of the plurality of RF filter units 200 and are detachably secured and electrically connected to respective front ends of the RF filter units 200.

Here, a module in which a single radiating element unit 300 is coupled to the filter body 210 of each of the plurality of RF filter units 200 may be defined as an antenna front-end module (hereinafter referred to as “AFEM”) 500.

Although not illustrated in the drawings, an existing antenna apparatus has the following configuration: a main board primarily disposed in an internal space of an antenna housing; a plurality of RF filter units mounted on a front surface of the main board at predetermined intervals in a predetermined matrix form; an antenna board having a single-board structure and stacked on front end portions of the plurality of RF filter units via a reflector; and a plurality of antenna elements mounted on a front surface of the antenna board according to channel capacity to establish RF communication for each RF chain. In this respect, the antenna apparatus 100 according to an embodiment of the present disclosure, which is modularized for each RF chain, differs from the existing configuration.

As referred to in FIGS. 4 to 6, the AFEM 500 may include the plurality of RF filter units 200 and the radiating element unit 300.

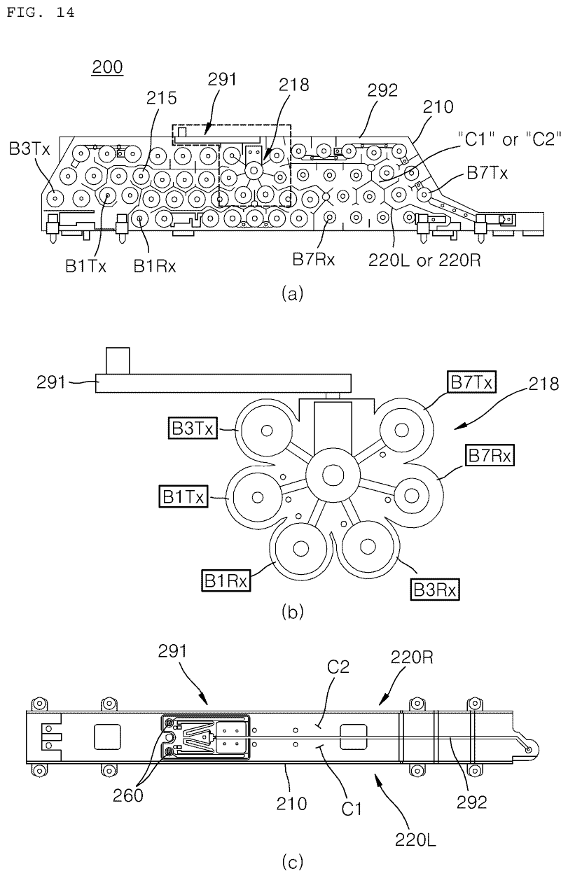

As referred to in FIGS. 5A, 5B, and 6, the plurality of RF filter units 200 may be formed as individual units, and may each be elongated in a vertical direction and include a filter body 210 in which a predetermined installation space is provided such that a plurality of resonators are embedded on left and right sides in a width direction for each TRx channel (see reference symbol “B1Tx,” etc., in FIG. 14 to be described below).

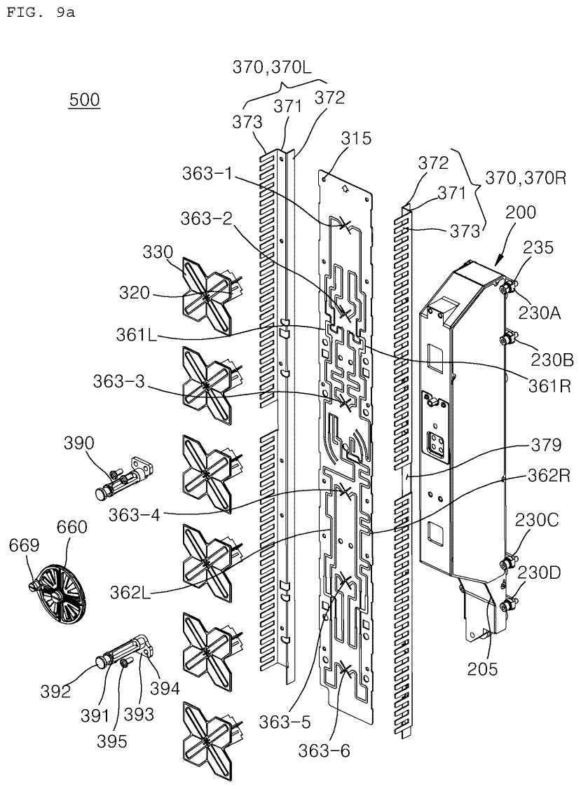

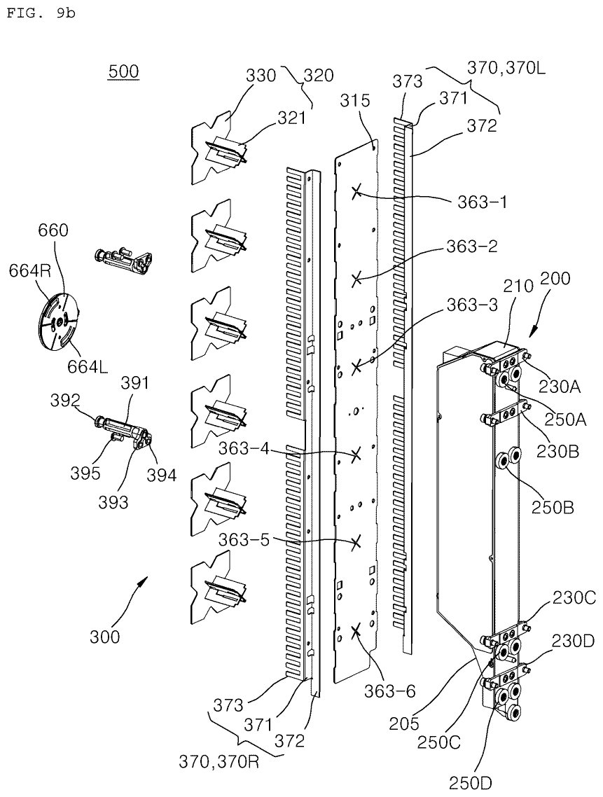

Furthermore, as referred to in FIGS. 5a, 5b, and 6, the radiating element unit 300 may include an antenna element board 310, which is secured to a front end surface of the filter body 210, and on which a plurality of transmission lines (see reference symbols “361L,” “361R,” “362L,” and “362R” in FIG. 9a to be described below) are printed in a pattern, and a plurality of antenna array elements 330 that are coupled to a front surface of the antenna element board 310 at positions spaced apart from each other in the vertical direction and configured to receive predetermined signals through the plurality of transmission lines 361L, 361R, 362L, and 362R.

More specifically, the plurality of RF filter units 200 may be electrically connected to filter connecting slots (not denoted by reference numerals) provided on a front surface of the main board 120 via a plurality of coaxial connectors (DCCs) 250A to 250D, and may also be electrically and stably coupled to the main board via a plurality of filter brackets 230A to 230D provided on a rear surface of the filter body 210 to prevent the connection portions to the coaxial connectors from moving arbitrarily.

However, it is to be understood that screw fastening by the plurality of filter brackets 230A to 230D is not directly performed on the main board 120, but rather may be performed on a clamshell panel 140 provided to block electromagnetic waves between the main board 120 and the plurality of RF filter units 200.

More specifically, as referred to in FIG. 4, the coaxial connectors 250A to 250D for connection to respective TRx channels may be provided on a rear surface of the filter body 210 at four positions spaced apart from each other in the vertical direction. In addition, the four filter brackets 230A to 230D may be arranged to be spaced apart from each other at predetermined intervals in the vertical direction as a structure configured to ensure stable electrical connection and coupling of the coaxial connectors 250A to 250D.

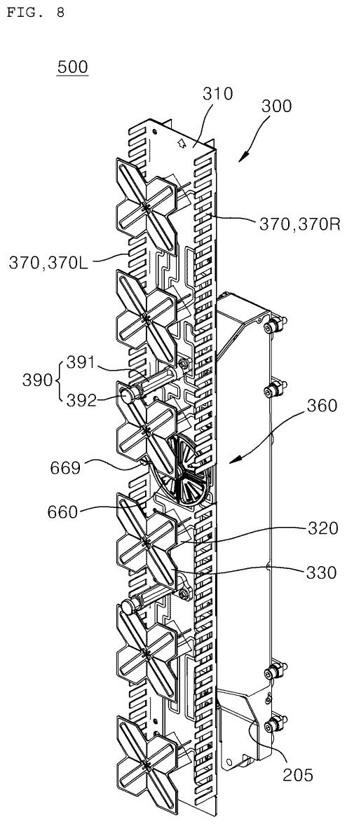

In the clamshell panel 140, DCC through-holes (not denoted by reference numerals), through which the coaxial connectors 250A to 250D provided at the four positions respectively pass, may be formed to penetrate the clamshell panel 140 in the front-rear direction at predetermined positions. A plurality of screw fastening holes (not denoted by reference numerals), into which fastening screws (see reference numeral “235” in FIG. 8) of the four filter brackets 230A to 230D are fastened, may also be provided in the clamshell panel 140.

As such, stable electrical signal connection (coupling) of the AFEM 500 to the main board 120 serves as an important factor in significantly preventing the occurrence of passive intermodulation distortion (PIMD).

More specifically, passive intermodulation distortion (PIMD) is a problem that occurs in general antenna apparatuses, and refers to a spurious signal caused by the nonlinear characteristics of passive components, which degrades communication quality by deteriorating the signal-to-noise ratio on the communication path.

Although the causes of the PIMD problem are diverse, one of the possible causes is that the antenna housing 110, which is generally elongated in the vertical direction, may undergo slight distortion due to thermal stress when thermal imbalance occurs due to the heat-generating elements 121 mounted on the main board 120. In this respect, the stable coupling and electrical connection to the main board 120 using the four filter brackets 230A to 230D as described above may contribute significantly to mitigating the PIMD problem.

A left filter 220L and a right filter 220R may be respectively provided on left and right sides in a width direction of the filter body 210 so as to enable filtering in a dual-band frequency range.

The left filter 220L and the right filter 220R may be configured to perform filtering for different frequency bandwidths separately. For example, the left filter 220L may be involved in a frequency band covering a low band that radiates frequencies defined between 600 MHz and 800 MHZ, and the right filter 220R may be involved in a frequency band covering a middle band that radiates frequencies defined between 1.7 GHZ and 2.4 GHz. In particular, the left filter 220L and the right filter 220R may each be implemented with a Quadflex filter.

In each of the left filter 220L and the right filter 220R, a relatively thin coupler may be inserted into and secured to a front end portion of the filter body 210 in a slit coupling manner. The coupler may be configured to combine the ends of a triple-band (6-path) structure into a common resonator and to substantially couple the six paths. A more detailed description of this configuration will be provided below.

As referred to in FIGS. 4 to 6, the filter body 210 may have a rectangular parallelepiped shape, in which a front-to-rear thickness is greater than a left-to-right width, and a vertical length is greater than the front-to-rear thickness.

In addition, the filter body 210 may have a chamfered shape at a portion of a front edge of one of a first end and a second end in a longitudinal direction, and a calibration port provided at a remaining one of the first end and the second end in the longitudinal direction. Furthermore, to allow vertical movement of a horizontal mounting bar 650 included in the configuration of a phase shifter 600 described below without interference, a rounded cut-out avoidance portion 205 may be integrally formed with the filter body 210.

When two antenna RF modules 500 according to an embodiment of the present disclosure are arranged successively in a vertical direction, respective one ends of the filter bodies 210, in which the avoidance portions 205 are formed, may come into contact with each other to form an approximate semicircular shape, thereby preventing an interference phenomenon during vertical movement of the horizontal mounting bar 650 of the phase shifter 600. Furthermore, the calibration ports of the respective filter bodies 210 may be positioned close to each other, thereby facilitating integrated connection to the main board 120.

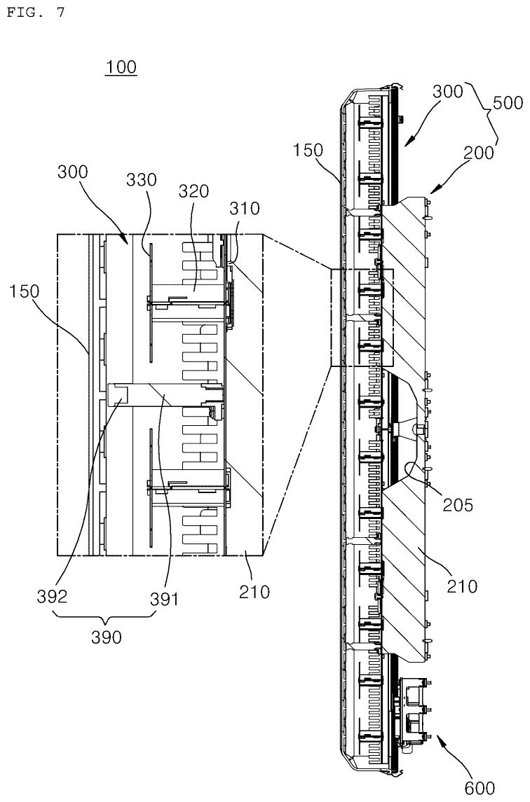

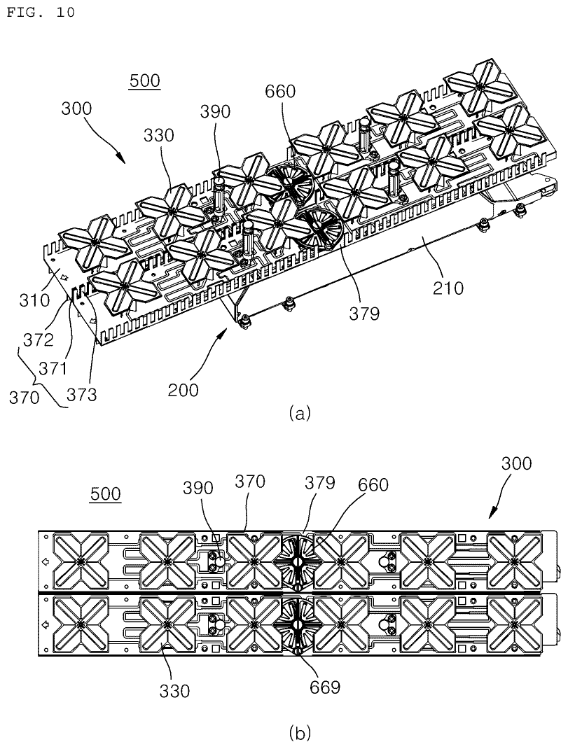

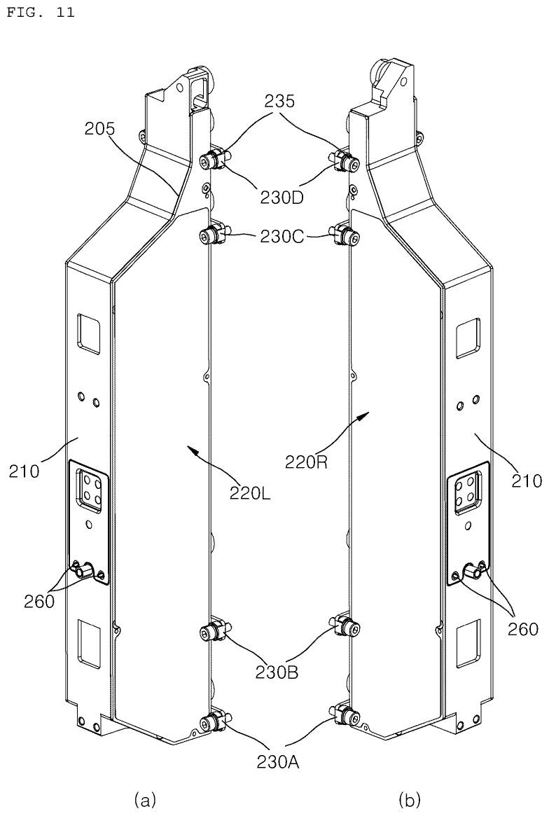

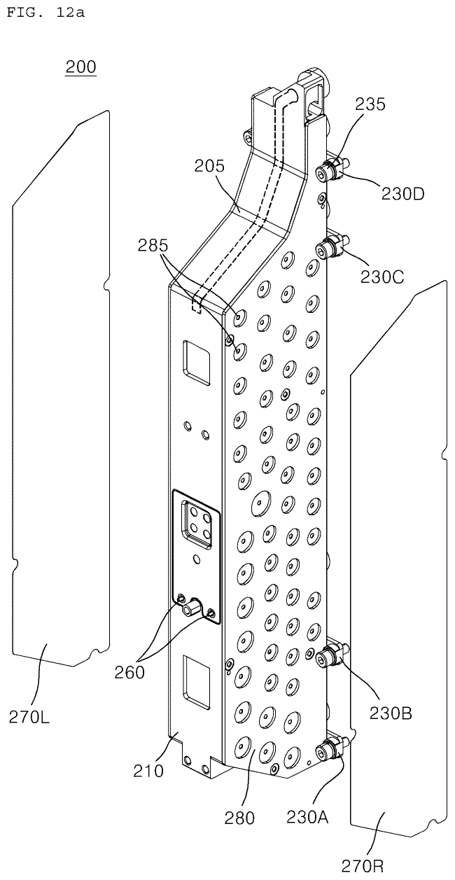

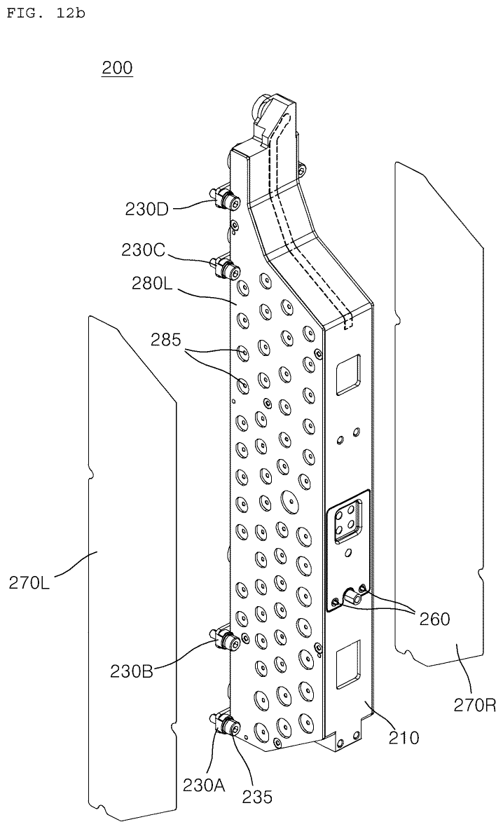

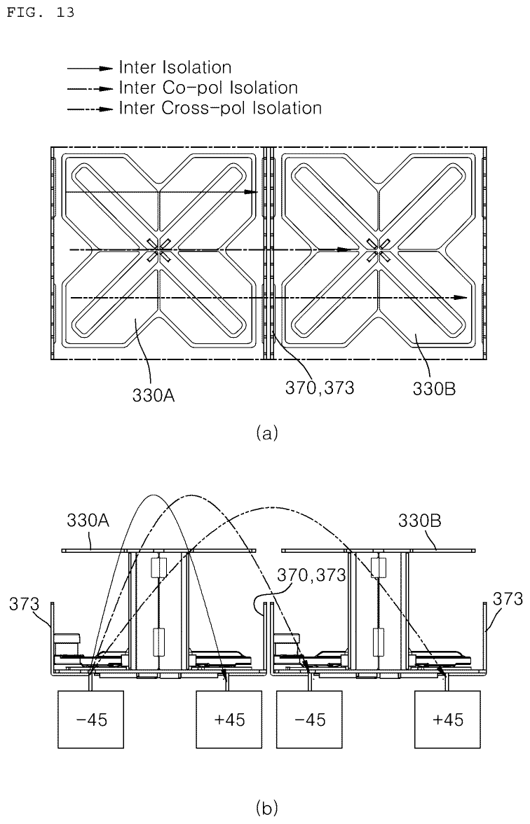

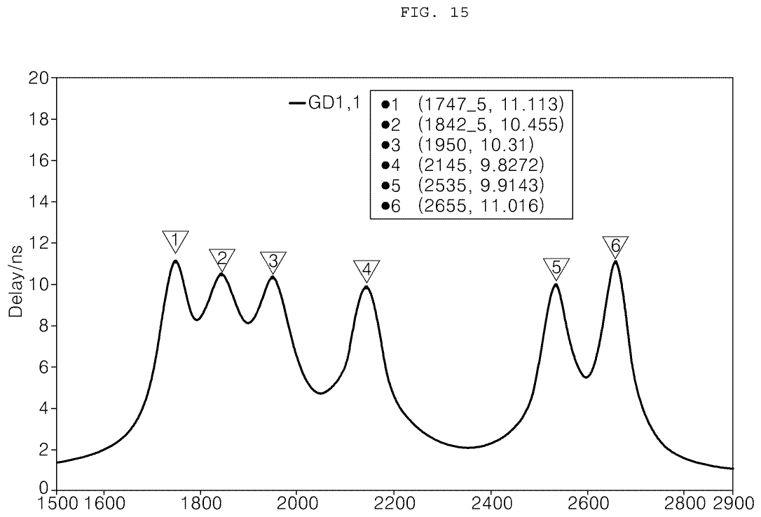

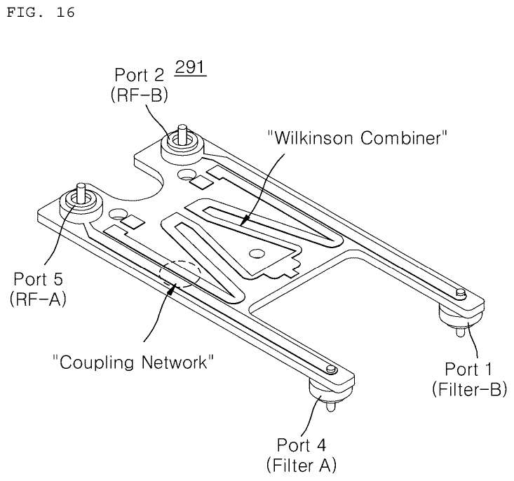

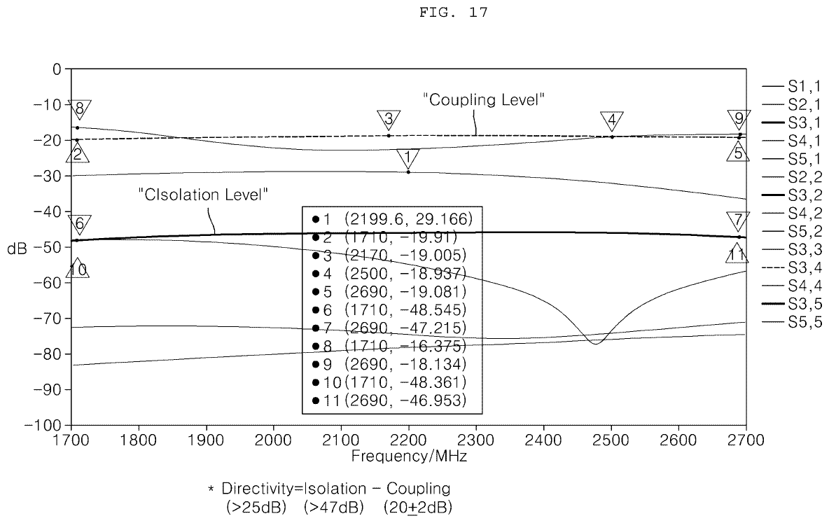

FIG. 7 is a cross-sectional view and a partially enlarged view for explaining the function of a support handle in the configuration of FIG. 2. FIG. 8 is a perspective view illustrating the RF module for antennas according to an embodiment of the present disclosure. FIGS. 9a and 9b are front and rear exploded perspective views of FIG. 8. FIG. 10 shows a perspective view (a) and a front view (b) for explaining a radio wave interference isolation wall in the configuration of FIG. 8. FIG. 11 is a perspective view illustrating an RF filter unit in the configuration of FIG. 8. FIGS. 12a and 12b are exploded perspective views of (a) and (b) of FIG. 11, respectively. FIG. 13 is a schematic view for explaining the interference effect affected by the radio wave interference isolation wall of FIG. 10. FIG. 14 shows a side view (a), a conceptual view (b), and an internal configuration view (c) illustrating a configuration of a common resonant component provided in a filter body of a plurality of RF filter units in the configuration of FIG. 10. FIG. 15 is a frequency characteristic graph exhibited by the common resonant component of FIG. 14. FIG. 16 is a perspective view illustrating a coupler in the configuration of FIG. 14. FIG. 17 is a frequency characteristic graph illustrating PIMD mitigated by the coupler of FIG. 16.

As referred to in FIGS. 7 to 17, the filter body 210 may further include filter tuning covers 280L and 280R, each of which is provided with a plurality of punching portions 285 to perform fine tuning by adjusting distances from leading ends of the plurality of resonators 215 (see (a) of FIG. 14) provided inside cavities C1 and C2 of the left filter 220L and the right filter 220R.

A tuning designer may perform fine tuning by punching each of the plurality of punching portions 285, formed on the filter tuning covers 280L and 280R, from the outside using a predetermined punching tool, to adjust distances from the leading ends of the resonators 215.

The foregoing configuration differs from an existing configuration in which a metal tuning screw corresponding to each resonator is provided and fine tuning is performed by finely rotating the tuning screw. By eliminating the relatively heavy metal tuning screws, the foregoing configuration facilitates lightweight product design and provides an advantage of mitigating the chronic PIMD problem by preventing imperfect contact of the metal tuning screws in advance.

The left filter 220L and the right filter 220R of the filter body 210 may further include a left filter cover 270L and a right filter cover 270R which respectively shield and cover the filter tuning covers 280L and 280R.

As described above, an input port portion 250 may be provided on the rear surface of the filter body 210 to achieve electrical connection with the main board 120 via the coaxial connectors 250A to 250D. An output port portion 260 may be provided on a front surface of the filter body 210 to supply power to the antenna element board 310, which is described below.

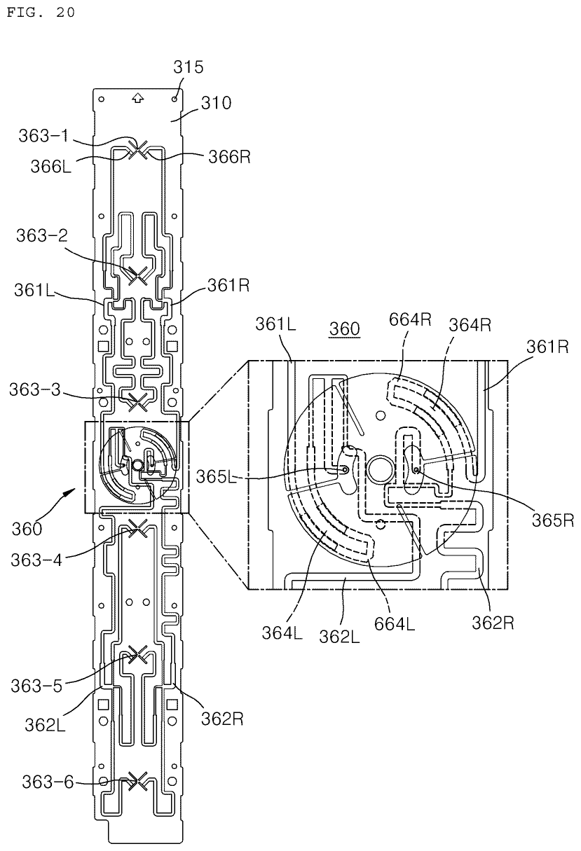

The output port portion 260 may be electrically connected pair of input terminals (see reference numerals 365L and 365R in FIG. 20) formed in a variable circuit pattern 360 of the phase shifter 600, which is described below, as a front-end transmission line before branching into a plurality of transmission lines 361L, 361R, 362L, and 362R printed in a pattern on the front surface of the antenna element board 310.

As referred to in FIGS. 8 to 10, the radiating element unit 300 of the AFEM 500 may include the antenna element board 310 and the plurality of antenna array elements 330.

Although the number of antenna array elements 330 is not limited, typically, three antenna elements may be arranged in a vertical direction (V-direction) for a single RF chain. Alternatively, as in an embodiment of the present disclosure, in the case where the physical transmission lengths of the plurality of transmission lines 361L, 361R, 362L, and branched into two from an input terminal rather than a digital stage are varied using the phase shifter 600, three additional antenna elements may be arranged in the V-direction (a total of six), and it is apparent that the number of antenna elements can be provided such that beamforming is implemented in a single RF chain by achieving a left-right symmetrical phase difference value with respect to the same phase plane.

To this end, as shown in FIG. 9a, the variable circuit pattern 360, which extends from a pair of input terminals and includes at least one open circuit point before branching into a plurality of transmission lines 361L, 361R, 362L, and 362R, and the plurality of transmission lines 361L, 361R, 362L, and 362R, which respectively extend from the open circuit point of the variable circuit pattern 360 toward upper and lower portions of a left front side and upper and lower portions of a right front side of the antenna element board 310 and branch into output terminals corresponding to the number of antenna array elements 330, may be printed in a pattern on the front surface of the antenna element board 310.

Here, the RF module 500 for antennas according to an embodiment of the present disclosure employs a configuration such that the antenna element board 310 is formed of a general printed circuit board (PCB) made of a flame-retardant glass epoxy resin (FR-4) material, and the variable circuit pattern 360 and the plurality of transmission lines 361L, 361R, 362L, and 362R are printed in a pattern thereon. However, the present disclosure is not necessarily limited to the aforementioned embodiment, and in order to reduce insertion loss, it is also possible to provide the antenna element board 310 in the form of a general plastic resin panel and design the variable circuit pattern 360 and the plurality of transmission lines 361L, 361R, 362L, and 362R as conductive terminals in the form of air strip lines.

On the front surface of the antenna element board 310, ‘X’-shaped installation slits 363-1 to 363-6, in which baluns 320 for supporting antenna patch elements (not labeled in the drawing) of a patch type or dipole type are installed, may be provided as locations where the above-described output terminals or antenna array elements 330 are positioned.

Although not illustrated, the baluns 320 may be provided with power supply pattern lines (not labeled in the drawing) made of a conductive material, which are electrically connected to respective output terminals of the plurality of transmission lines 361L, 361R, 362L, and 362R, and supply power to the plurality of antenna array elements 330 provided on front end portions of baluns 320, so that radiation of frequency beams such as dual-polarized beams is enabled.

As referred to in FIG. 9b, each of the baluns 320 may include a pair of power supply support ends 321, which are inserted into and secured in a corresponding one of the installation slits 363-1 to 363-6 formed in the antenna element board 310 and are formed to intersect in an ‘X’ shape, and an element support end (not illustrated) coupled to the front ends of the pair of power supply support ends 321 to support the antenna array element 330 formed of an antenna patch element.

In addition, as referred to in FIGS. 7 to 10, at least two or more radome deformation prevention protrusions 390 may be provided on the front surface of the antenna element board 310. A front end of each of the radome deformation prevention protrusions 390 may protrude further forward than the antenna array element 330 and is supported by the rear surface of the radome panel 150.

The radome deformation prevention protrusions 390 function to prevent the antenna array elements 330 from being brought into contact with and deformed by the radome panel 150 in the event that the front surface of the radome panel 150 is accidentally pressed rearward by a worker (referring to a worker who installs the antenna apparatus according to the present disclosure).

In addition, the radome deformation prevention protrusions 390 may also function as gripping portions for holding with fingers and easily moving the unit AFEM 500 when the unit AFEM 500 is coupled (mounted) to the main board 120 by an assembler.

Here, as referred to in FIGS. 7, 9a, and 9b, each of the radome deformation prevention protrusions 390 may include a support rod 391, a rear end portion of which is fastened to the antenna element board 310 by a fixing screw 395, and a height adjustment screw 392 provided on a front end of the support rod 391 and supported by the rear surface of the radome panel 150.

A screw fixing panel 393 having a screw through-hole 394 therein may be integrally formed on a rear end portion of the support rod 391. The radome deformation prevention protrusion 390 may be stably secured in place by an operation of fastening at least one fastening screw 395 to the antenna element board 310 through the screw through-hole 394.

In the case where a gap is caused by an assembly tolerance of the radome panel 150, the height adjustment screw 392 performs a function of eliminating the gap caused by the assembly tolerance, through rotational adjustment with respect to the support rod 391.

In this manner, it becomes possible to minimize in advance the occurrence of PIMD, which may occur due to deviations from the design range caused by deformation in the coupling or positioning of each component of the antenna apparatus by an assembler or worker involved from the assembly process to the installation process of the antenna RF module 500.

In the antenna apparatus 100 according to an embodiment of the present disclosure, the AFEM 500, as referred to in FIGS. 8 to 10, may further include radio wave interference isolation walls 370, which are respectively coupled to opposite ends of each of the plurality of radiating element units 300 in a width direction and disposed in a partitioned manner to minimize radio wave interference with adjacent radiating element units 300. Each of the radio wave interference isolation walls 370 has a front end portion partially cut in a concave-convex shape, and has a rear end portion coupled in surface contact with a front end of the filter body without cutting so as to increase a contact area with the front end portion of the filter body.

As referred to in FIGS. 9a and 9b, the radio wave interference isolation wall 370 may include a left isolation wall 370L installed and secured to a left end of the antenna element board 310 in the width direction, and a right isolation wall 370R installed and secured to a right end of the antenna element board 310 in the width direction.

The radio wave interference isolation wall 370 having the aforementioned structure may be made of a metal material capable of blocking electromagnetic waves, and may serve not only to prevent interference with antenna beams of adjacent AFEMs 500 and improve beam patterns, but also to enhance the overall strength of the AFEM 500.

As referred to in FIGS. 9a and 9b, the radio wave interference isolation wall 370 may include: a mounting surface 371 that is bent to at least partially overlap a rear surface of a corresponding one of opposite ends in a width direction of each of the plurality of radiating element units 300 so as to mediate coupling to the front end of each of the plurality of RF filter units 200 corresponding to the plurality of radiating element units 300; a radio wave isolation surface 373 bent forward from the mounting surface 371 and formed in a concave-convex shape; and a grounding surface 372 bent from the mounting surface 371 toward the filter body 210 without cutting.

In other words, as referred to in FIGS. 9a and 9b, the radio wave interference isolation wall 370 may be integrally formed such that the grounding surface 372 protruding rearward with respect to the antenna element board 310 and the radio wave isolation surface 373 protruding forward are bent from an inner end and an outer end, respectively, of a mounting surface 371 that is provided parallel to the antenna element board 310.

Here, as described above, the radio wave isolation surface 373 of the radio wave interference isolation wall 370 may be formed in a concave-convex shape in which ridges and grooves are repeatedly provided to form a spacing distance suitable for beam pattern characteristics, thereby improving beam pattern characteristics according to each embodiment.

In addition, unlike the above-described radio wave isolation surface 373, the grounding surface 372 of the radio wave interference isolation wall 370 may be provided in a form in which no concave-convex shape is formed, in order to enhance the grounding function of the antenna element board 310.

To this end, the mounting surface 371 of the radio wave interference isolation wall 370 may be brought into close contact with and coupled to a rear surface of either the left end or the right end of the antenna element board 310 in the width direction. The grounding surface 372 of the radio wave interference isolation wall 370 may be bent and extended as far rearward as possible, thereby further extending the grounding functional surface of the antenna element board 310.

A brief description of the effect of preventing interference of polarized beams by the radio wave interference isolation wall 370, which is a component of the AFEM 500 of the antenna apparatus 100 according to an embodiment of the present disclosure, is as follows. As referred to in (a) and (b) of FIG. 13, radiation beams emitted from one of two AFEMs 500 arranged to be aligned in a left-right horizontal direction (H-direction) (e.g., radiation beams emitted from the antenna array element 330A on the left side in the drawing) may be divided into: an inter-isolation polarized beam (see solid arrow) that causes interference inside the same AFEM 500 without reaching the adjacent AFEM 500 (e.g., the antenna array element 330A on the right side in the drawing); an inter co-pol isolation polarized beam (see dash-dot arrow) that reaches the antenna array element 330B of the adjacent AFEM 500 and causes interference; and an inter cross-pol isolation polarized beam (see dash-double-dot arrow) that passes over the antenna array element 330B of the adjacent AFEM 500 and causes interference with the antenna array element 330 of another adjacent AFEM 500 not shown.

Here, in the antenna apparatus 100 according to an embodiment of the present disclosure, the AFEM 500 may minimize interference, as radiation beams toward an adjacent AFEM 500 are shielded or reflected by the above-described radio wave interference isolation wall 370 and thus return.

The antenna element board 310 of the radiating element unit 300 may be fastened to the front end surface of the filter body 210, among the components of the AFEM 500, through a fastening screw (not shown). However, only the fastening screw is not necessarily used as a fastening element. In addition, it may be possible to fasten the grounding surface 372, which is a rear end portion of the radio wave interference isolation wall 370, to a side surface of the filter body 210 in the width direction through a separate fastening screw.

It is apparent that the specific shape of the radio wave interference isolation wall 370 may be designed in consideration of radiation characteristics of polarized beams according to each embodiment.

In addition, as referred to in FIGS. 9a and 9b, the radio wave interference isolation wall 370 may be provided with an interference-avoiding hole 379 for interference-free hinge rotation (i.e., preventing interference) at a junction with vertical mounting bars 655U and 655D, which are provided and connected for the rotation of variable switch panels 660 of the components of the phase shifter 600, which is described below.

The interference-avoiding hole 379 is preferably designed to be formed at an optimal position of the radio wave interference isolation wall 370, which is determined in consideration of polarized beam radiation characteristic data, as will be described below, and accordingly, it will be apparent that the detailed shape design of the vertical mounting bars 655U and 655D may also be modified.

In particular, among the components of the phase shifter 600 to be described below, each of the plurality of vertical mounting bars 655U and 655D is disposed to move in the vertical direction adjacent to an inner side of one of a pair of radio wave interference isolation walls 370 provided at opposite ends of the corresponding antenna element board 310 in the width direction. Here, the movement of the vertical mounting bars 655U and 655D is not a completely vertical linear motion.

In other words, each of the variable switch panels 660 of the phase shifter 600 is configured to rotate about a predetermined rotation center point, and each of the vertical mounting bars 655U and 655D are connected to a rotation connection point 669 of the corresponding variable switch panel 660 and move accordingly. Accordingly, each of the vertical mounting bars 655U and 655D perform a swing movement such that an upper end thereof (i.e., the rotation connection point 669) swings at a slight angle with respect to a lower end thereof.

In this case, securing a space required for the swing movement of the vertical mounting bars 655U and 655D is essential. Although it may be considered to fabricate the antenna element board 310 with a larger width, such an approach is not adoptable because it causes an increase in the left-right width size of the antenna apparatus.

Therefore, in order to prevent interference with the slight swing movement of the vertical mounting bars 655U and 655D while avoiding an increase in size, the optimal design solution may be to design the interference-avoiding hole 379 in the radio wave interference isolation wall 370 as described above.

However, in the case where the concave-convex shape of the radio wave isolation surface 373, which is the front end portion of the radio wave interference isolation wall 370, is initially formed such that a sufficient spacing distance is ensured within the concave-convex portion, the spacing distance of the concave-convex portion may substitute for the interference-avoiding hole 379, and thus a separate design of the interference-avoiding hole 379 may not be necessary.

Each of the plurality of RF filter units 200 may include: the filter body 210 including the left filter 220L and the right filter 220R, which are respectively provided in the form of cavities on one side and a remaining side in a width direction, as referred to in FIG. 14; and a common resonant component (not designated by a reference numeral, see (b) of FIG. 14) disposed on an end of each of at least two or more multi-bands (in an embodiment of the present disclosure, three frequency bands (B1: 2100, B3: 1800, B7: 2600)), which are built in the left filter 220L and the right filter 220R of the filter body 210.

As referred to in FIG. 14, the common resonant component may include a common resonator 218 disposed at the center of each of cavities C1 and C2 of the left filter 220L and the right filter 220R, which respectively include respective ends of the multi-bands, and may further include a coupler 291 and a divider 292 electrically connected to the common resonator 218.

According to the common resonant component configured as described above, a role of enabling transmission and reception of signals related to multiple frequency bands may be performed.

For example, when the left filter 220L and the right filter 220R are each configured with a plurality of resonators to build a transmission path for selectively transmitting signals of a plurality of frequency bands (in the present disclosure, the three frequency bands (B1: 2100, B3: 1800, B7: 2600)) as a multi-band, the common resonator 218 may be configured to include resonators 215 positioned at respective input and output ends of the plurality of frequency bands (for example, the three pairs of frequency bands).

More specifically, the coupler 291 may perform a role of extracting a portion of a signal from each of the left filter 220L and the right filter 220R, and the divider 292 may perform a role of combining the two coupled signals into a single output.

Although the coupler 291 is illustrated in the drawings (see (c) of FIG. 14 and FIG. 16) as being provided in the form of a substrate to form a thickness capable of being inserted and secured in a slit-coupling manner in the front end portion of the filter body 210, it should be noted that the form of the coupler 291 is not necessarily limited to the substrate form. That is, as long as the coupler 291 forms a thickness capable of being inserted and fixed by a slit-coupling manner in the front end portion of the filter body 210 and does not cause an increase in the overall size of the filter body 210, any form may be employed.

As in the case of the divider 292 referred to in (c) of FIG. 14, the coupler 291 may also be provided in the form of a conductive pattern formed on the filter body 210.

More specifically, as referred to in FIG. 16, the coupler 291 is provided such that signals of frequency bands selected by the common resonator 218 are input through Port 1 (Filter B, i.e., the left filter 220L) and Port 4 (Filter A, the right filter 220R), and are transmitted and received through Port 2 (RF-B) and Port 5 (RF-A), which function as the above-described output port portion 260, by using a main circuit (not designated by a reference numeral).

In addition, the coupler 291 may transmit signals, which are coupled through a coupling network circuit and a Wilkinson combiner circuit that are disposed in parallel and adjacent to the above-described main circuit, to a calibration port through the divider 292.

According to the coupler 291 functioning as described above, as shown in the frequency characteristic diagram referred to in FIG. 17, a stabilized coupling value may be implemented within an error range of ‘20 dB±1 dB’ for the coupling level in a frequency band ranging from 1.7 GHZ to 2.7 GHZ, even without coupling tuning, and the isolation level is equal to or greater than 47 dB (Isolation Level >47 dB). Accordingly, a satisfactory directivity value equal to or greater than 25 dB may be secured based on the following equation.

Directivity=Isolation−Coupling [Equation]

In addition, referring to FIG. 16, since the ground of the coupler 291 provided in a PCB type is connected to the filter body 210 through a coupling ground, unstable contact can be prevented (no unstable contact), and thus, there is an advantage in that the PIMD problem can be remarkably mitigated.

For reference, although not illustrated in the drawings, the ground of the coupler 291 and the filter body 210 may be connected in a coupling form without direct contact, for example, by using double-sided tape or photo solder resist (PSR) treatment.

With the aforementioned configuration, the plurality of RF filter units 200 may create an advantage of maximizing versatility and marketability by constructing, inside each filter body 210, a triple band (a 6-path (transmission filter path) filter, a coupler 291, and a divider 292), so as to match each public frequency of a region or country where the antenna apparatus 100 according to an embodiment of the present disclosure is installed.

In addition, in the antenna apparatus 100 according to an embodiment of the present disclosure, even when the left filter 220L and the right filter 220R are provided, as in the AFEM 500, an advantage of preventing an increase in the size of the RF filter unit 200 is provided, since a single coupler 291 can be mounted by a slit-coupling manner inside the front end portion of the filter body 210, without providing the number of couplers 291 corresponding to the respective filters 220L and 220R.

Furthermore, as described above, in the case where a single coupler 291 is provided inside the front end portion of the filter body 210, the configuration of the main circuit and the coupling network circuit related to the left filter 220L, the main circuit and the coupling network circuit related to the right filter 220R, and the Wilkinson combiner circuit for calibration is not only simplified, but also the formation of the divider 292 provides an additional manufacturing advantage in that the divider 292 can directly extend toward the calibration port along the front end portion of the filter body 210.

According to the plurality of RF filter units 200 as described above, individual frequency characteristics based on the 6-path (transmission filter path) structure can be implemented, as referred to in FIG. 15.

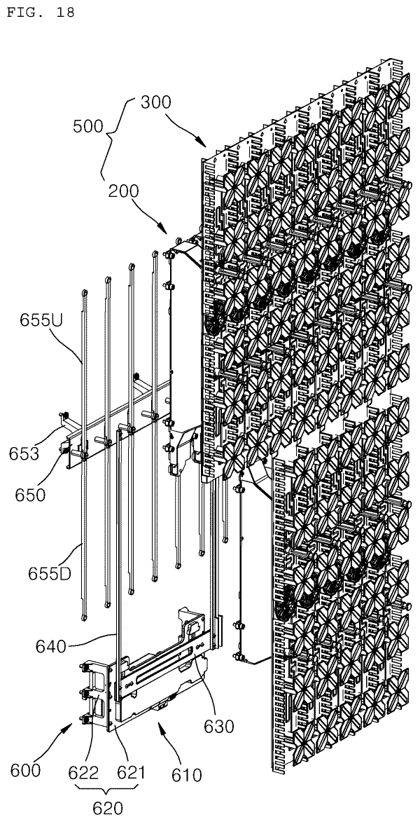

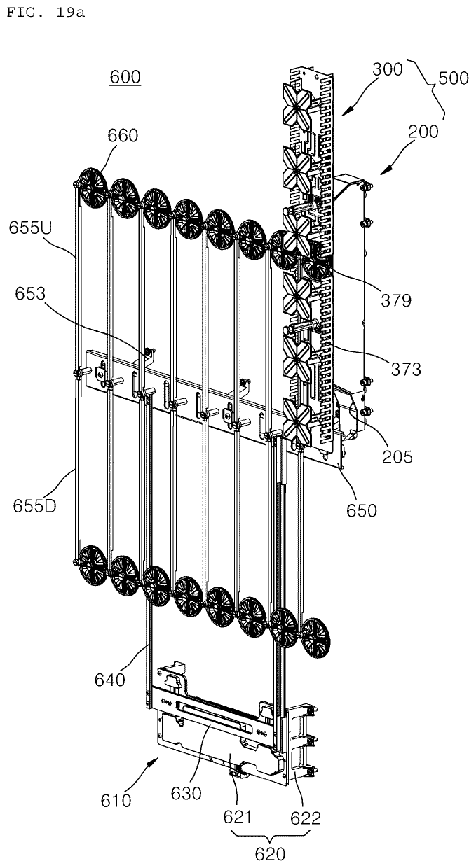

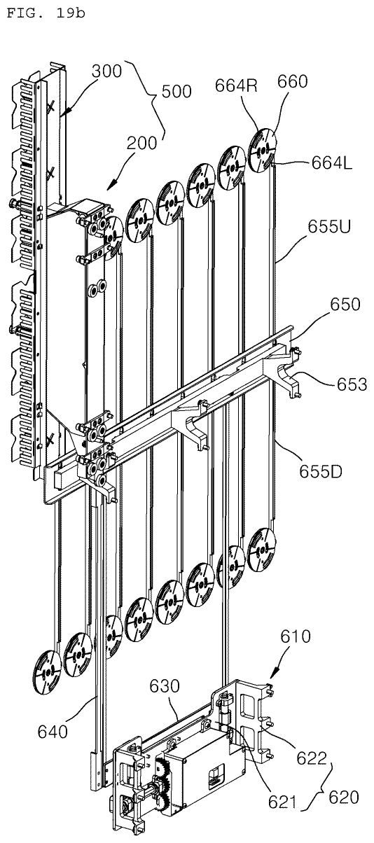

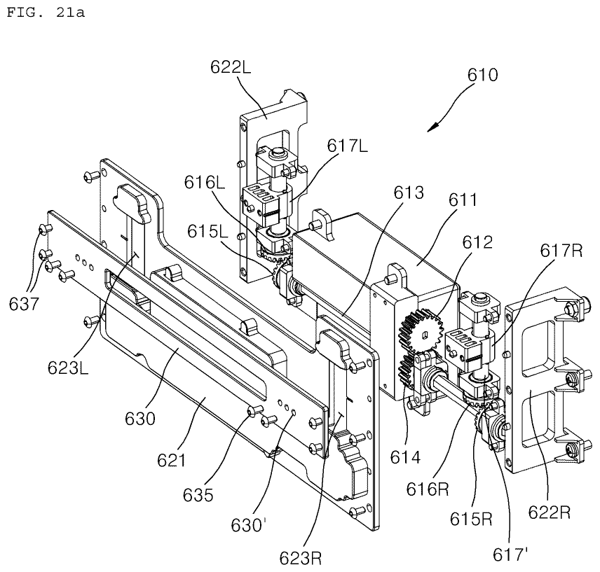

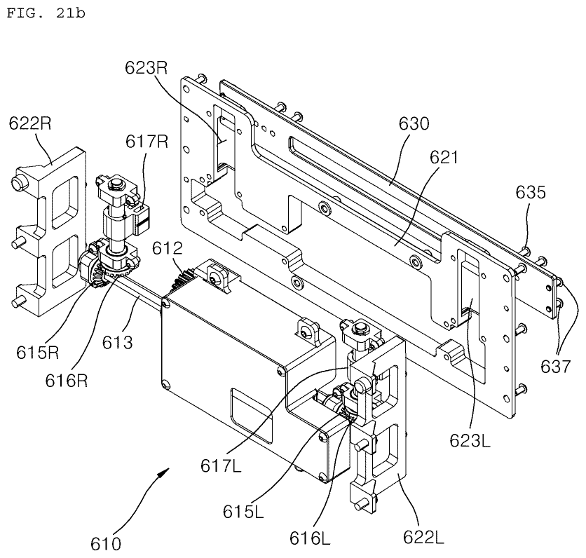

FIG. 18 is a perspective view illustrating installation of the phase shifter that changes the length of a physical transmission line through the variable contact pattern provided in the radiating element unit in the configuration of FIG. 1. FIGS. 19a and 19b are front and rear perspective views illustrating the phase shifter in a state in which only a single RF module for antennas remains in the configuration of FIG. 18. FIG. 20 is a diagram illustrating a transmission line configuration for explaining a change in physical transmission length due to the operation of the variable switch panel for the variable circuit pattern of FIG. 18. FIGS. 21a and 21b are front and rear exploded perspective views illustrating a drive unit among the components of the phase shifter of FIG. 18.

As referred to in FIGS. 18 to 21b, the antenna apparatus 100 according to an embodiment of the present disclosure may further include the phase shifter 600 configured to perform beam forming with a predetermined phase difference value obtained through changing physical lengths of the plurality of transmission lines 361L, 361R, 362L, and 362R printed in a pattern on the front surface of the antenna element board 310.

According to an embodiment, the phase shifter 600 may obtain a phase difference value with a left-right symmetrical slope with respect to the same phase plane by changing the physical lengths of the plurality of transmission lines 361L, 361R, 362L, and 362R.

The phase shifter 600 may include: a drive motor unit 610 which is secured in a lower portion of the internal space 110S of the antenna housing 110 and configured to electrically generate rotational driving force; a vertical moving guide unit 620 configured to convert the rotational driving force of the drive motor unit 610 into linear motion to move vertically; a horizontal mounting bar 650 configured to receive the linear moving force from the vertical moving guide unit 620 and move in a vertical direction while maintaining a horizontal orientation; and a plurality of vertical mounting bars 665U and 665D, each having one end connected perpendicularly in the vertical direction to the horizontal mounting bar 650, and a remaining end connected to the rotation connection point 669 of the above-described variable switching panel 660, which is disposed to be switching-grounded to respective open circuit points of the plurality of transmission lines 361L, 361R, 362L, and 362R.

As referred to in FIGS. 21a and 21b, the drive motor unit 610 may include a drive motor (not shown) provided in a motor box 611, a first pinion gear 612 coupled to opposite ends of a rotation shaft of the drive motor, a rotation shaft 613 disposed parallel to the rotation shaft of the first pinion gear 612, and a second pinion gear 614, which engages with the first pinion gear 612 and is provided on opposite ends of the rotation shaft 613.

A pair of interlocking second-pinion gears 615L and 615R, which interlock with the second pinion gear 614, may be provided on opposite ends of the rotation shaft 613 of the second pinion gears 614. A pair of interlocking bevel gears 616L and 616R, disposed to have rotation shafts perpendicular to the pair of interlocking second pinion gears 615L and 615R, may engage with the pair of interlocking second pinion gears 615L and 615R, respectively.

Screw rods 617′, each having an external thread (not shown) formed on an outer circumferential surface thereof, may be shaft-coupled to rotation shafts of the pair of interlocking bevel gears 616L and 616R. Vertical moving guide blocks 617L and 617R, each having an internal thread (not shown) engaging with the external thread of the corresponding screw rod 617′, may be respectively threaded onto the outer circumferential surfaces of the pair of screw rods 617′.

The motor box 611 may be secured to motor mounting brackets 622L, 622R, and 621, which include a pair of left and right motor mounting brackets 622L and 622R and a front motor mounting bracket 621, configured to mediate securing the motor box 611 in the internal space 110S of the antenna housing 110. The front motor mounting bracket 621 may be screw-fastened to the pair of left and right motor mounting brackets 622L and 622R by a plurality of fastening screws 637.

In front of the front motor mounting bracket 621 among the motor mounting brackets 622L, 622R, and 621, a vertical moving panel 630, which is a component of the above-described vertical moving guide unit 620, may be installed to move in the vertical direction.

The vertical moving panel 630 may move vertically in conjunction with the pair of moving blocks 617L and 617R described above. For this purpose, moving guide slots 623L and 623R, which guide the vertical movement of the pair of upper and lower moving blocks 617L and 617R, are formed to pass through the front motor mounting bracket 621 in a front-rear direction, and the vertical moving panel 630 may be screw-fastened to the moving blocks 617L and 617R through the moving guide slots 623L and 623R by a plurality of fastening screws 635.

A pair of vertical connection bars 640, which mediate connection with the above-described horizontal mounting bar 650, may be connected to the vertical moving panel 630, which is a component of the vertical moving guide unit 620.

When the drive motor unit 610 configured as described above operates, rotational driving force of the drive motor is converted into vertical linear motion by the vertical moving guide unit 620, so that the horizontal mounting bar 650 moves in the vertical direction while maintaining left-right balance. As the plurality of vertical mounting bars 655U and 655D, which are connected to move vertically in conjunction with the horizontal mounting bar 650, move, the variable switch panel 660 is rotated at a predetermined angle, and a variable contact pattern 664R formed on a facing surface of the variable switch panel 660 performs a conduction operation at at least one open circuit point formed in the variable circuit pattern 360, thereby enabling the physical lengths of the plurality of transmission lines 361L, 361R, 362L, and 362R to be changed.

At present, mobile data traffic is increasing exponentially. Accordingly, global mobile carriers are in competition to expand mid-band frequency division duplex (FDD) capacity, such as 1.8 GHz and 2.1 GHZ bands.

As a solution for capacity expansion, the 5G FDD Dual Band Massive MIMO radio unit (RU) with 32 transmit/receive channels (32TRX) is gaining global attention. However, as described above, there are two critical issues that limit commercialization.

The first issue is the occurrence of PIMD. PIMD is pointed out as a critical problem that severely reduces uplink coverage of base stations by degrading receiver sensitivity.

The second issue is that the FDD RU is extremely heavy and oversized because it uses 128 filters, each of which is twice the size of a time division duplex (TDD) filter. This has also been an obstacle to commercialization.

The antenna apparatus 100 according to an embodiment of the present disclosure proposes the most innovative commercialization solution that fundamentally blocks the occurrence of PIMD at the hardware level and reduces size and weight.

The starting point of the above-described solution is the modularized design of the RF filter unit 200 and the radiating element unit 300, as described above. In contrast to the existing installation structure in which a plurality of antenna array elements are arranged in an H-V array on a single antenna element board, the antenna apparatus 100 according to an embodiment of the present disclosure has the following four advantages, and includes the following innovative technologies based on extensive experience of the applicant of the present disclosure.

### Disruptive Technology (Extremely LOW PIMD, Significantly Reduced Weight)

The filter tuning technology refers to automatically tuning the filter without using screws. To this end, a plurality of punching panels are provided on a filter cover (not shown) at positions corresponding to the leading ends of the respective resonators so as to perform fine tuning, and fine tuning can be automatically performed through an automatic punching tool. In addition, all components of the RF filter unit 200 are soldered so that imperfect contact between metals does not occur, thereby eliminating the fundamental cause of PIMD and allowing the RF filter unit 200 to have a significantly lighter weight than an existing one.

In addition, in the antenna apparatus 100 according to an embodiment of the present disclosure, an exclusive filter cover bonding technology is applied, which is an exclusive adhesion technique for airtightly bonding the filter body 210 and the filter cover without using screws. Accordingly, both PIMD and the weight of the RF filter unit 200 may be significantly reduced, and in particular, a dual-sided quad-flex filter may be implemented, thereby providing a thinner and lighter structure.

Furthermore, in a final stage of assembling the RF filter unit 200 and the radiating element unit 300, PIMD may be fundamentally eliminated by directly assembling the RF filter unit 200 and the radiating element unit 300 without contact points or additional connectors.

### Detachable Architecture (Highest Production Yield, Each Module Replaceable)

In an existing method, although the assembly sequence may vary, antenna element arrays (radiating element components) and RF filter units are assembled individually on a single PCB (main board), making it nearly impossible to identify the location where PIMD has occurred. Even when the location of PIMD is identified, addressing or correcting the issue remains significantly difficult.

However, a modular design such as the antenna apparatus 100 according to an embodiment of the present disclosure enables assembly in a detachable module type, similar to Lego blocks, thereby markedly increasing production yield.

Scalable Architecture (Reducing Lead Time, Easy Response to Frequency Variance, Compatible with Various Antenna Architectures)

In addition, the above-described modular design has scalable compatibility because all types of FDD massive MIMO RUs can be constructed using only three types of modules (triple band type). Furthermore, the modular design allows for reduced lead time and facilitates response to frequency variance.

### Dual Channel Phase Shifter (for Hybrid Beamforming (Optional))

In addition, as an optional component, the dual channel phase shifter 600 for hybrid beamforming may support up to 384 antenna element architectures. This leads to advantages of being smaller, lighter, and significantly more cost-efficient compared to existing products.

In other words, the AFEM 500, corresponding to a modular-type design of the antenna apparatus 100 according to an embodiment of the present disclosure, provides advantages of significantly improving PIMD elimination, weight reduction, separability and scalability, and universality through the dual channel phase shifter.

The antenna apparatus 100 according to embodiments of the present disclosure has been described in detail with reference to the accompanying drawings. However, the present disclosure is not necessarily limited by the embodiments, and various modifications of the embodiments and any other embodiments equivalent thereto may of course be carried out by those skilled in the art to which the present disclosure pertains. Accordingly, the true protection scope of the present disclosure should be determined by the appended claims.

### INDUSTRIAL APPLICABILITY

The present disclosure provides a radio frequency (RF) module for antennas and an antenna apparatus including the RF module, which may not only minimize radio wave interference between modules, but also prevent indirect coupling of beams radiated from a radiating element unit and mitigate a passive intermodulation distortion (PIMD) issue.

1. A radio frequency (RF) module for antennas, comprising:
a plurality of RF filter units each including a filter body formed to be elongated in a vertical direction; and
a plurality of radiating element units detachably secured and electrically connected to respective front ends of the plurality of RF filter units,
wherein each of the plurality of RF filter units comprises:
the filter body comprising a left filter and a right filter respectively provided in a form of cavities on one side and a remaining side in a width direction of the filter body; and
a common resonant component disposed on an end of each of at least two or more multi-bands built in the left filter and the right filter of the filter body.

2. The RF module of claim 1, wherein the common resonant component comprises:
a common resonator disposed at a center of the cavities of the left filter and the right filter that include the respective ends of the multi-bands; and
a coupler and a divider electrically connected to the common resonator.

3. The RF module of claim 2,
wherein the multi-bands comprise a plurality of resonators configured to build a plurality of transmission paths that selectively transmit signals of a plurality of frequency bands,
wherein the common resonator is configured to include resonators respectively positioned at input ends and output ends of the plurality of frequency bands.

4. The RF module of claim 3, wherein a signal selected by the common resonator is transmitted to the plurality of radiating element units or a calibration port via the coupler and the divider.

5. The RF module of claim 2, wherein the coupler and the divider are secured to a front end portion of the filter body adjacent to the cavity of the left filter or the right filter.

6. The RF module of claim 2, wherein each of the coupler is formed to have a thickness suitable for being inserted and secured in a slit-coupling manner inside a front end portion of the filter body.

7. An antenna apparatus, comprising:
a radio frequency (RF) module for antennas, comprising a plurality of RF filter units each including a filter body formed to be elongated in a vertical direction;
an antenna housing formed in an enclosure shape with an open front side and an internal space formed to receive the RF module; and
a radome panel configured to shield an open front end portion of the antenna housing and protect the RF module from an outside,
wherein the RF module comprises:
the filter body comprising a left filter and a right filter respectively provided in a form of cavities on one side and a remaining side in a width direction of the filter body; and
a common resonant component disposed on an end of each of at least two or more multi-bands built in the left filter and the right filter of the filter body.

8. The antenna apparatus of claim 7,
wherein the RF module further comprises a plurality of radiating element units detachably secured and electrically connected to respective front ends of the plurality of RF filter units, the plurality of radiating element units including a plurality of antenna array elements coupled to front ends thereof and configured to output a beam with at least one polarization of dual polarizations,
wherein the radome panel includes, on a rear surface thereof, a decoupling pattern portion formed in a predetermined shape to minimize indirect coupling between the plurality of antenna array elements.

9. The antenna apparatus of claim 8, wherein the decoupling pattern portion is formed in an ‘X’ shape among regions provided in a rhombus shape and a honeycomb shape.

10. The antenna apparatus of claim 7, wherein the radiating element unit of the RF module comprises at least one radome deformation prevention protrusion provided to support a rear surface of the radome panel.

11. The antenna apparatus of claim 8,
wherein each of the plurality of radiating element units comprises an antenna element board (antenna PCB) which is secured to a front end of the filter body via the radio wave interference isolation walls, and on which a variable circuit pattern electrically connected to a pair of input terminals and a plurality of transmission lines extending to be branched from the variable circuit pattern into at least one branch and electrically connected to a plurality of output terminals each provided as a pair, are printed in patterns, and
wherein the filter body is formed with an avoidance portion cut out to prevent interference with power transmission to a variable switch panel that is disposed in front of the variable circuit pattern and configured to move to vary physical lengths of the plurality of transmission lines.

12. The antenna apparatus of claim 7, wherein the common resonant component comprises:
a common resonator disposed at a center of the cavities of the left filter and the right filter that include the respective ends of the multi-bands; and
a coupler and a divider electrically connected to the common resonator.

13. The antenna apparatus of claim 12, wherein the coupler and the divider are secured to a front end portion of the filter body adjacent to the cavity of the left filter or the right filter.
